(19) United States
(12) Patent Application Publication
(10) Pub. No.: US 2023/0166578 A1
(43) Pub. Date: Jun. 1, 2023

(54) METHOD FOR TRIGGERING A FUNCTION OF A MOTOR VEHICLE ADAPTED TO A LIVING BEING

(71) Applicant: Dr. Ing. h.c. F. Porsche Aktiengesellschaft, Stuttgart (DE)

(72) Inventor: Lukas Maeurer, Berlin (DE)

(21) Appl. No.: 17/961,085

(22) Filed: Oct. 6, 2022

(30) Foreign Application Priority Data
Nov. 26, 2021 (DE) 10 2021 131 114.4

(51) Int. Cl. B60H 1/00; G01S 13/04

(52) U.S. Cl. CPC B60H 1/00742; G01S 13/04

(57) ABSTRACT

The invention relates to a method for triggering a motor vehicle (100) function adapted to a living being (104; 201; 301; 304) located in an interior of the motor vehicle (100). The method includes emitting electromagnetic radiation (102; 305), reflecting the electromagnetic radiation (102; 305) by the living being (104; 201; 301; 304); receiving the reflected electromagnetic radiation (105; 200); detecting the living being (104; 201; 301; 304) based on the reflected electromagnetic radiation (205; 200); and triggering a motor vehicle (100) function adapted to the living being (104; 201; 301; 304).

### CROSS-REFERENCE TO RELATED APPLICATION

This application claims priority on German Patent Application No 10 2021 131 114.4 filed Nov. 26, 2021, the entire disclosure of which is incorporated herein by reference.

### BACKGROUND

Field of the Invention. The invention relates to a method for triggering a function of a motor vehicle adapted to a living being.

Related Art. US 2016/0001728 A1 discloses a method that uses electromagnetic radiation for determining the presence of persons in a motor vehicle and the position of these persons.

### SUMMARY

The invention relates to a method for making a stay in a vehicle more attractive. More particularly, an embodiment of the method includes emitting electromagnetic radiation, for example, from a first antenna of the motor vehicle. This can be electromagnetic radiation that serves a further purpose, for example communication between electronic devices. The electromagnetic radiation can be WiFi, Bluetooth, or mobile radio radiation or radiation of a locking system of the motor vehicle, for example “keyless go”. The emitted radiation is reflected by the living being in the interior of the motor vehicle. The reflected radiation is received, for example, using a second antenna of the motor vehicle or an electronic device, for example a mobile phone. The reflected electromagnetic radiation is used to detect the living being. The detection then triggers a function of the motor vehicle, and specifically a function that is adapted to the living being. This function can be triggered, for example, by a communication of the electronic device with the motor vehicle. Alternatively, the function can be triggered on the electronic device. This function that is adapted to the individual living being, increases the quality of the stay for the respective living being in the vehicle.

According to one embodiment, the living being can be detected as a particular person, and the function can be adapted to that person. In this case, for example, the person can have previously defined the function. This increases the quality of the stay for the person to a particular extent.

According to one embodiment, the function can comprise a retrieval of a profile adapted to the individual. The profile can include settings relating to a position of a seat of the motor vehicle, in particular the seat on which the person is seated, a target temperature of a region in the interior of the motor vehicle, a type of music, and/or a volume of an audio playback device. These settings can be adjusted to the person's needs, so that they do not have to manually access the settings to feel particularly comfortable.

According to some embodiments, the presence and the position of the living being can be detected. The function then can be adapted to the detected position. In this case, the function can relate to an air conditioning of the interior of the motor vehicle. In some embodiments, the air conditioning is switched on only for seats of the motor vehicle that are occupied by living creatures. Thus, energy is saved by not heating or less heating or not cooling unoccupied seats.

According to one embodiment, the presence and a posture of the living being may be detected. The function can then be adapted to the posture. For example, an orientation or a position of a seat can be adjusted so that the posture of the living being is influenced positively.

According to some embodiments, the function can comprise outputting an indication of an ergonomic posture via an audio and/or image rendering means of the motor vehicle. For example, a posture that is disadvantageous to the person from ergonomic aspects can be pointed out, and at the same time an indication of a better posture from an ergonomic perspective can also be given. This also increases the well-being of the person in the vehicle, at least in the long term.

According to some embodiments, the function can comprise a switching-on operation of an air conditioning system of the motor vehicle, depending on an identity or characteristics of the living being and on a temperature within and/or in an environment of the motor vehicle. For example, the living being can be recognized as a dog or child. Then, the switching on of the air conditioning system at a particularly high temperature within the motor vehicle or in the environment of the motor vehicle can be beneficial to avoid becoming too hot for the child or dog. Likewise, at a particularly low temperature within the motor vehicle or in the environment of the motor vehicle, it can be advantageous to use the air conditioning to heat up the interior so as to avoid becoming too cold for the child or dog.

According to some embodiments, the function can be triggered when the temperature within the motor vehicle and/or in an environment of the motor vehicle is above an upper threshold value and/or below a lower threshold value.

This disclosure also relates to an apparatus that comprises an electronic digital storage unit and an electronic digital processing unit that can comprise, for example, a processor. Instructions are stored in the storage unit. The processing unit is configured to read out and execute the instructions. The processing unit further may be designed to carry out the above-described method when executing the instructions.

The apparatus can be an electronic device, such as a mobile phone. It is also possible for the apparatus to be part of a motor vehicle.

This disclosure also relates to a motor vehicle that comprises the above-described apparatus.

Further features and advantages of the present invention become apparent from the following description of an exemplary embodiment, with reference to the appended illustrations. The same reference numbers are used for the same or similar features and for features with the same or similar functions.

### BRIEF DESCRIPTION OF THE DRAWINGS

FIG. 1 shows a schematic view of a motor vehicle according to an embodiment of the invention with a person in the interior;

FIG. 2 shows a schematic view of the motor vehicle of FIG. 1 with a dog in the interior; and

FIG. 3 shows a schematic view of the motor vehicle from FIG. 1 with two persons and electronic devices in the interior.

### DETAILED DESCRIPTION

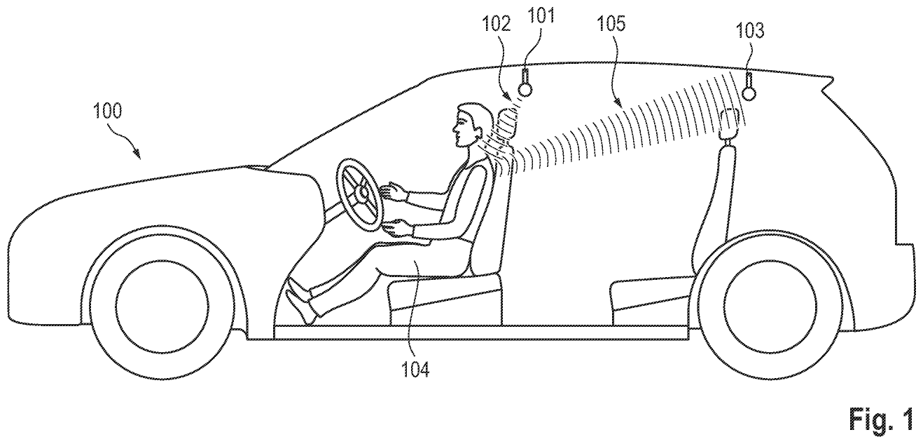

At the outset, it should be understood that should be understood that the elements and functions described herein and shown in FIGS. 1-3 may be implemented in various forms of hardware, software or combinations thereof. These elements may be implemented in a combination of hardware and software on one or more appropriately programmed general-purpose devices, which may include a processor, memory and input/output interfaces. The term “coupled” as used or implied herein mean directly connected to or indirectly connected with through one or more intermediate components. Such intermediate components may include both hardware and software-based components.

Those skilled in the art will appreciate that the Figures represent conceptual views of illustrative circuitry embodying the principles of the disclosure and/or also represent various processes that may be represented substantially in computer readable media and so executed by a computer or processor, whether or not such computer or processor is explicitly shown.

The functions described herein may be carried out with a control unit that may be provided through the use of dedicated hardware as well as hardware capable of executing software in association with appropriate software. In one embodiment, some or all of the functions may be performed by at least one processor, such as a computer or an electronic data processor, digital signal processor or embedded micro-controller, in accordance with code, such as computer program code, software, and/or integrated circuits that are coded to perform such functions, unless indicated otherwise. When provided by a processor, the functions may be provided by a single dedicated processor, by a single shared processor, or by a plurality of individual processors, some of which may be shared. Moreover, the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage. Other hardware, conventional and/or custom, may also be included in the control unit, such as a memory, input/output interfaces, a wireless transceiver, analog-to-digital converters, etc.

A motor vehicle 100 in accordance with this disclosure has a transmitting antenna 101 that emits electromagnetic radiation 102 and a receiving antenna 103 that receives electromagnetic radiation. A person 104 seated in the interior of the motor vehicle 100 reflects the electromagnetic radiation 102, and the reflected electromagnetic radiation 105 is received by the receiving antenna 103.

Conclusions can be drawn from the reflected electromagnetic radiation 105 about the position and dimensions of the person 104. For example, a processing unit can recognize the person 104 as an adult in the driver's seat of the motor vehicle. The height and approximate weight of the person 104 also can be detected. For example, these characteristics can be used to identify the individual as person X. Another person, for example, who is smaller and lighter, can be identified as person Y. A function of the motor vehicle 100 can be triggered depending on the detected person 104. For example, a profile can have been defined previously for the person 104, and this profile can relate to a seat position, mirror settings, or type and volume of the music. It is also possible that the function will consider the person's position. For example, an air conditioning can be optimized specifically for this position.

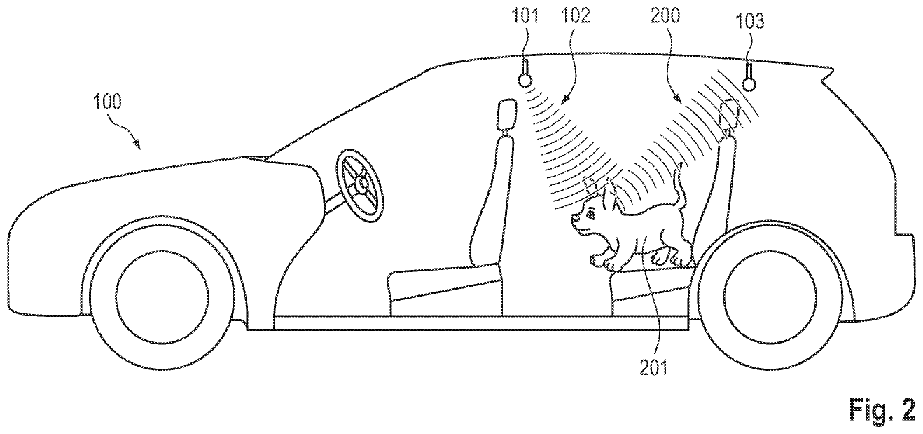

In FIG. 2, a dog 201 is on a rear seat of the motor vehicle 100. The dog 201 reflects the electromagnetic radiation as reflected electromagnetic radiation 200 to the receiving antenna 103. The dog 201 in the rear seat can be recognized from the reflected electromagnetic radiation 200. If, for example, the temperature in the interior of the motor vehicle then rises above a threshold value, e.g. 30° C., an air conditioning of the interior can be activated so that the dog 201 is protected from excess temperatures. This function is particularly useful for a dog 201 and for a child, as they are often not able to open doors or windows of the motor vehicle independently.

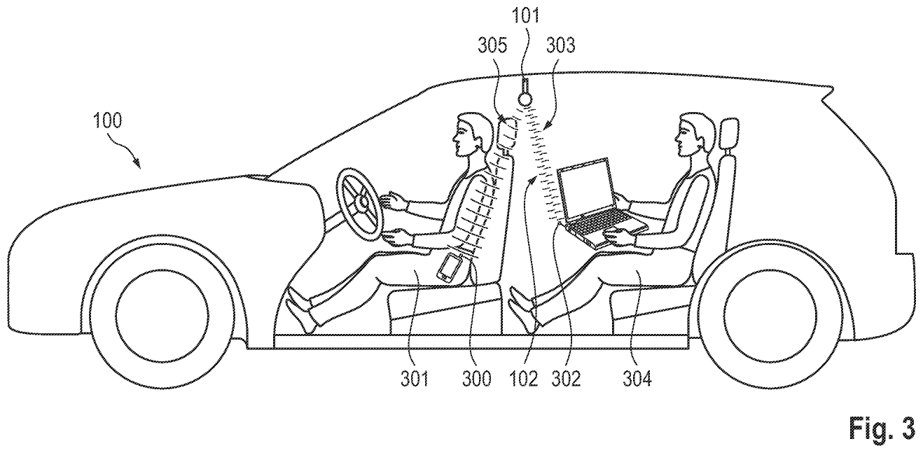

FIG. 3 shows a first person 301 seated in the driver's seat with a first electronic device 300 and a second person 304 seated in a rear seat with a second electronic device 302. In addition to the electromagnetic radiation reflected by the persons 301 and 304, which is not shown in FIG. 3 for reasons of clarity, the position of the person 304 can be determined from electromagnetic radiation 303 emitted by the electronic device 302. The position of the person 301 can be determined by electromagnetic radiation 305 transmitted from the transmitting antenna 101, for example, when the electromagnetic radiation 305 is transmitted to the electronic device 300 with specific properties. This can be, for example, electromagnetic radiation 305 that is specifically transmitted towards the electronic device 300.

The electronic device 300 can also be used to detect the person 301 or the person 304. Alternatively, this can be performed by an apparatus installed in the motor vehicle. The apparatus or device 300 can subsequently trigger a function in the motor vehicle 100.

1. A method for triggering a motor vehicle (100) function adapted to a living being (104; 201; 301; 304), wherein the living being (104; 201; 301; 304) is located in an interior of the motor vehicle (100), the method comprising:
emitting electromagnetic radiation (102; 305);
reflecting the electromagnetic radiation (102; 305) by the living being (104; 201; 301; 304);
receiving the reflected electromagnetic radiation (105; 200);
detecting the living being (104; 201; 301; 304) based on the reflected electromagnetic radiation (205; 200); and then
triggering a motor vehicle (100) function adapted to the living being (104; 201; 301; 304).

2. The method of claim 1, wherein the detecting the living being (104; 201; 301; 304) comprises detecting the living being (104; 201; 301; 304) as a particular person (104; 301; 304) and the method further comprises adapting the function to the particular person (104; 301; 304).

3. The method of claim 2, wherein the function comprises a retrieval of a profile adapted to the person (104; 301; 304), the profile includes at least one of a setting with respect to a position of a seat of the motor vehicle (100), a target temperature of a region in the interior of the motor vehicle (100), a type of music, and/or a volume of an audio playback apparatus.

4. The method of claim 1, wherein detecting the living being (104; 201; 301; 304) comprises detecting a position of the living being (104; 201; 301; 304), and the method comprises adapting the function to the detected position.

5. The method of claim 1, wherein detecting the living being (104; 201; 301; 304) comprises detecting a posture of the living being (104; 201; 301; 304), and the method comprises adapting the function to the posture.

6. The method of claim 5, further comprising outputting an indication of an ergonomic posture via an audio and/or image rendering means of the motor vehicle (100).

7. The method of claim 1, further comprising a switching-on operation of an air conditioning system of the motor vehicle (100) depending on the living being (104; 201; 301; 304) and a temperature within the motor vehicle (100) and/or in an environment of the motor vehicle (100).

8. The method of claim 7, wherein the function is triggered when the temperature within the motor vehicle (100) and/or in an environment of the motor vehicle (100) is above an upper threshold value and/or below a lower threshold value.

9. An apparatus comprising an electronic digital storage unit and an electronic digital processing unit, instructions being stored in the storage unit, the processing unit being configured to read out and execute the instructions, the processing unit being configured to perform the of claim 1 when executing the instructions.

10. A motor vehicle (100) comprising the apparatus of claim 1.
